(19) United States
(12) Patent Application Publication
(10) Pub. No.: US 2006/0142142 A1
(43) Pub. Date: Jun. 29, 2006

(54) Process for improving basestock low temeperature performance using a combination catalyst system

(75) Inventors: William J. Murphy, Baton Rouge, LA (US); Ian A. Cody, Baton Rouge, LA (US); Robert J. Wittenbrink, Kingwood, TX (US); Stuart L. Soled, Pittstown, NJ (US); Gary B. McVicker, Califon, NJ (US); Sylvain Hantzer, Purcellville, VA (US); Sandra J. Linek, Williamstown, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(73) Assignee: ExxonMobile Research and Engineering Company, Annandale, NJ (US)

(21) Appl. No.: 10/532,143

(22) PCT Filed: Nov. 12, 2002
(86) PCT No.: PCT/US02/36522

§ 371 Date: Jan. 10, 2006

Related U.S. Application Data
(63) Continuation-in-part of application No. 09/601,552, filed on Nov. 16, 2000, now abandoned.
(60) Provisional application No. 60/074,722, filed on Feb. 13, 1998.

(51) Int. Cl. B01J 29/04

(52) U.S. Cl. 502/60

(57) ABSTRACT

Waxy feeds are converted to a basestock using a unitized mixed powdered pellet catalyst comprising a metal hydrogenation component on a support having a frist dewaxing component and a second isomerization component, wherein the first component is selected from 10 and 12 ring molecular sieves and mixtures thereof and the second component is an amorphous inorganic oxide. The first and second components are present in a ratio sufficient to promote wax isomerization and naphthene distractions without substantial decrease in VI.

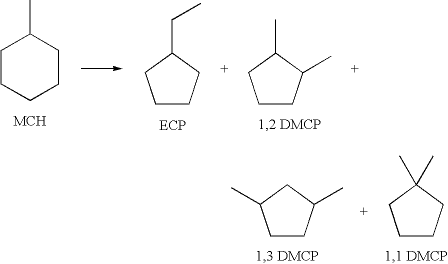

### FIELD OF THE INVENTION

This invention relates to the hydrodewaxing of waxy feeds including slack wax, slack wax isomerate, Fischer-Tropsch wax, Fischer-Tropsch hydroisomerate, waxy raffinates, and waxy distillates to produce a lube oil basestock or blending stock. More specifically, this invention relates to the conversion of a waxy feed using a mixed catalyst capable of promoting wax isomerization and naphthene destruction to form a lube basestock with minimum VI loss and having good low temperature properties.

### BACKGROUND OF THE INVENTION

The performance criteria for lubricants such as those used in automatic transmission fluids and passenger car engine oils has become increasingly more severe with users requiring basestock that provide better wear protection, improved volatility and low temperature properties.

Waxy feeds can be converted to liquid products using well known catalytic dewaxing catalysts; however, in these instances the selective cracking of paraffins typically results in a loss of viscosity index (VI) which is undesirable.

U.S. Pat. No. 4,428,865, Oleck, et al., claims a method to enhance the pour point and viscosity index of crude oils of high wax content by contacting the highly waxy feed with two different zeolites such as ZSM-5 and ZSM-35.

In contrast, isomerization of waxy feeds using molecular sieve based catalyst that have linear 1D pore structures produces lube basestocks without loss in VI. While this isomerization process offers benefits over that of catalytic dewaxing there nonetheless remains a need for different and improved processes for converting waxy feeds to lube basestocks without significant loss in VI and which basestock has good low temperature properties.

### SUMMARY OF THE INVENTION

This invention relates to a method for the hydrodewaxing of feeds to produce a lube basestock having improved low temperature properties which comprises:
(a) contacting the feed with a unitized mixed powder pellet catalyst under hydrodewaxing conditions, said catalyst comprising:
   (i) a first dewaxing component selected from 10 and 12 ring molecular sieves and mixtures thereof having a metal hydrogenation component dispersed thereon;
   (ii) a second component selected from amorphous inorganic oxides said second component having a metal hydrogenation component dispersed thereon; and
   (iii) wherein said first and second components are present in a ratio such that when evaluated in the conversion of methyl cyclohexane at 320° C. to 1,1-dimethylcyclopentane, 1,2-dimethylcyclopentane, 1,3-dimethylcyclopentane and ethylcyclopentane, the catalyst will provide a trans-1,2-/trans-1,3-dimethylcyclopentane ratio in the range of about 1:1 to about 1:2 and a selectivity to ethylcyclopentane, at 10% conversion, of at least about 50%.

In another embodiment of the present invention both the first and second component comprise at least one 10 or 12 ring molecular sieve or a mixture thereof. Both the first and second component have a metal hydrogenation component dispersed thereon.

This and other embodiments of the invention will be discussed below.

### BRIEF DESCRIPTION OF THE DRAWINGS

FIG. 1 is a schematic drawing showing the conversion of methylcyclohexane to various cyclopentane compounds at 320° C.

FIG. 2 is a graph showing Brookfield viscosity vs. yield for various catalyst mixtures.

### DETAILED DESCRIPTION OF THE INVENTION

The feed suitable in the practice of the present invention includes waxy hydrocarbon oils such as slack wax, slack wax isomerate, Fischer-Tropsch wax, Fischer-Tropsch hydroisomerate, waxy raffinates and waxy distillates. Typically, such feeds will have wax contents of 15% or more. The preferred feed will have a nitrogen and sulfur content each below about 20 wppm by weight. Indeed, if the feed contains higher amounts of sulfur and nitrogen, the feed can be first subjected to hydrotreating under typical hydrotreating conditions to reduce the sulfur and nitrogen contents. Any of the conventional hydrotreating catalysts can be employed like Ni/Mo on alumina, Ni/W on alumina Co/Mo on alumina. In other words any of the Group VIB to Group VIII metals and mixtures thereof (the metal groups referred to here and hereinafter are those metals of the Periodic Table of Elements; Sargent-Welch Scientific Co.) on metal oxide refractory supports may be employed. Non-limiting commercial examples of such are identified as HDN-30, KF-840, KF-848, etc.

Hydrotreating is conducted so as to lower the sulfur and nitrogen contents to levels of 20 ppm or less nitrogen or 20 ppm or less sulfur especially 10 ppm less nitrogen and 10 ppm or less sulfur and most preferably to levels below 5 ppm for nitrogen and 5 ppm or less for sulfur.

Waxy feeds secured from natural petroleum sources contain quantities of sulfur and nitrogen compounds which are known to deactivate wax hydroisomerization catalysts. To prevent this deactivation it is preferred that the feed contain no more than 10 ppm sulfur, preferably less than 2 ppm sulfur and no more than 2 ppm nitrogen, preferably less than 1 ppm nitrogen.

To achieve these limits the feed is preferably hydrotreated to reduce the sulfur and nitrogen content.

Hydrotreating can be conducted using any typical hydrotreating catalyst such as Ni/Mo on alumina, Co/Mo on alumina, Co/Ni/Mo on alumina, e.g., KF-840, KF-843, HDN-30, HDN-60, Criteria C-411, etc. Similarly, bulk catalysts comprising Ni/Mn/Mo or Cr/Ni/Mo sulfides as described in U.S. Pat. No. 5,122,258 can be used.

Hydrotreating is performed at temperatures in the range 280° C. to 400° C., preferably 340° C. to 380° C. at pressures in the range 500 to 3000 psi, hydrogen treat gas rate in the range of 500 to 5000 SCF/bb1 and a flow velocity in the range 0.1 to 5 LHSV, preferably 1 to 2 LHSV.

The hydrotreated waxy oil is stripped to remove ammonia and H₂S and then is subjected to the hydrodewaxing process of the present invention.

The catalyst employed in the hydrodewaxing of waxy feeds in accordance with the present invention is a unitized mixed powdered pellet catalyst. The term “unitized” as used here and in the claims means that each pellet is one made by mixing together a powdered first catalytic component with a powdered second catalytic component and pelletizing the mixture to produce pellets each of which contain all of the powder components previously recited.

The unitized catalyst can be prepared by starting with individual finished catalysts, pulverizing and powdering such individual finished catalysts, mixing the powdered materials together to form a homogeneous mass, then compressing/extruding and pelleting thus producing the unitized pellet catalysts comprising a mixture of the individual, different, and distinct catalyst components. Pulverizing and powdering is to a consistency achievable using a mortar and pestle or other such conventional powdering means.

The catalyst used in the process of the present invention comprises a metal hydrogenation component on a two component support. The metal hydrogenation component is at least one of a Group VIB or Group VIII metal, preferably a Group VIII metal, and more preferably Pt, Pd, and mixtures thereof. The metal is dispersed on both components. Typically the metal will be present in an amount ranging from about 0.1 to about 30 wt. %, and preferably about 0.1 to 10 wt. %. If the metal is a Group VIII noble metal, then the preferred amount is 0.1 to 5 wt. %. The catalyst may also include a substantially inert binder or matrix material.

The first component is a catalytic dewaxing component including crystalline 10 and 12 ring molecular sieves. Crystalline molecular sieves include alumino silicates and alumino phosphates. Examples of crystalline alumino silicates include zeolites such as ZSM-5, ZSM-11, ZSM-12, Theta-1 (ZSM-22), ZSM-23, ZSM-35, natural and synthetic ferrierites, ZSM-48, ZSM-57, SSZ-31, Beta, Mordenite, Offretite, ECR-42, MCM-71, and ITQ-13. Examples of crystalline alumino phosphates include SAPO-11, SAPO-41, SAPO-31, MAPO-11 and MAPO-31. Preferred molecular sieves include ZSM-5, ZSM-22, ZSM-23, ZSM-48, ferrierites, SSZ-31, SAPO-11, ECR-42, MCM-71, and ITQ-13. The most preferred molecular sieves are ZSM-48, ECR-42, MCM-71, SSZ-31, and ITQ-13.

The second isomerization component can be any of the typical isomerization catalyst such as those comprising amorphous refractory metal oxide support base (e.g., alumina, silica-alumina, zirconia, titania, etc.) on which has been preferably deposited a catalytically active metal selected from Group VI B, Group VII B, Group VIII metals and mixtures thereof, preferably at least one Group VIII, more preferably at least one noble Group VIII, most preferably Pt, Pd, and mixtures thereof, and optionally including a promoter or dopant such as halogen, phosphorus, boria, yttria, rare earth oxides, from e.g., La, Ce, etc., magnesia, etc. preferably halogen, yttria or magnesia, most preferably fluorine. The catalytically active metals are present in the range 0.1 to 5 wt. %, preferably 0.1 to 3 wt. %, more preferably 0.1 to 2 wt. %, most preferably 0.1 to 1 wt. %. The promoters and dopants are used to control the acidity of the isomerization catalyst. Thus, when the isomerization catalyst employs a base-material such as alumina, acidity is imparted to the resultant catalyst by addition of a halogen, preferably fluorine. When a halogen is used, preferably fluorine, it is present in an amount in the range 0.1 to 10 wt. %, preferably 0.1 to 3 wt. %, more preferably 0.1 to 2 wt. %, most preferably 0.5 to 1.5 wt. %. Similarly, if silica-alumina is used as the base material, acidity can be controlled by adjusting the ratio of silica to alumina or by adding a dopant such as yttria, rare earth oxides, from, e.g., La, Ce, etc., boria or magnesia which modifies the acidity of the silica-alumina base material as taught on U.S. Pat. No. 5,254,518 (Soled, McVicker, Gates, Miseo).

It is also contemplated herein that both the first and second components be at least one crystalline 10 or 12 ring molecular sieve. The first and second components can also be selected from mixtures of 10 and 12 ring molecular sieves. Thus, both the first and second components can be selected from any of the 10 and 12 ring molecular sieves listed above, and mixtures thereof. It is preferred that the first component be ITQ-13 and the second component be selected from ZSM-48, ZSM-35, ZSM-22, ZSM-23, ZSM-57, SSZ-31, and mixtures thereof. It is more preferred that the first component be selected from ITQ-13, ZSM-57, and mixtures thereof, and the second component be selected from ZSM-22, ZSM-23, ZSM-35, ZSM-48, SSZ-31, and mixtures thereof.

The first and second components are combined in a ratio sufficient to promote wax isomerization and napthene destruction without substantial decrease in VI. The zeolite to amorphous inorganic oxide ratios for catalysts according to the invention range from about 1:1 to 1:20 by weight, subject to the MCH test described below.

One technique for determining the proper ratio of first and second components in the catalyst is based on an evaluation of the combined components containing about 0.5 wt. % Pt in converting methylcyclohexane (MCH) to various cyclopentane compounds. Catalyst that at 320° C. provide a ratio of trans 1,2-dimethylcyclopentane to trans 1,3-dimethylcyclopentane (trans-1,2/trans-1,3 DMCP) in the range of greater than one, e.g., 1:1 to 2:1 have been found to promote wax isomerization and naphathene destruction of feeds without substantial decrease in VI.

The second factor is when the catalyst, impregnated with about 0.5 wt. % Pt and evaluated in converting methylcyclohexane (MCH) to various cyclopentane compounds at 10% conversion, exhibits a selectivity for ethylcyclopentane (ECP) formation above at least 50%.

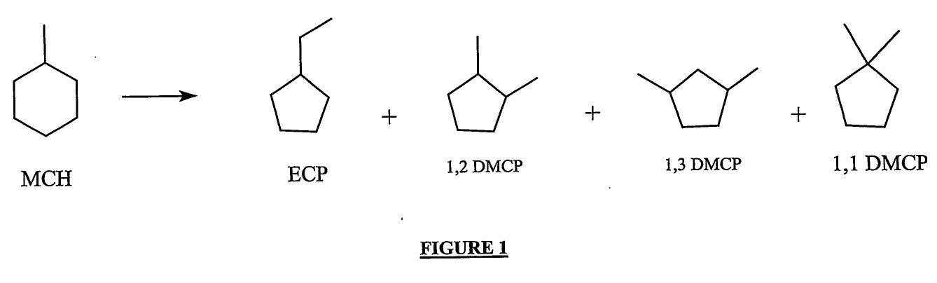

This technique is further explained as follows. The reaction of MCH over the catalyst to various cyclopentane products is shown in FIG. 1. As indicated in FIG. 1, the products of MCH decomposition include ethylcyclopentane, cis- and trans-1,2-dimethylcyclopentane, cis- and trans-1,3-dimethylcyclopentane and 1,1 dimethylcyclopentane. This technique, also known as the MCH test is used to define relative acid site concentration, strengths and active site constraint for the catalysts according to the invention.

The key factors are summarized as follows: (1) total conversion of MCH for a given catalyst weight at 320° C. is an indication of the relative number of acid sites; (2) selectivity to ECP, at 10% conversion, is a measure of the relative acid strength wherein high ECP selectivity values indicates low acid strength and low ECP selectivity values indicates high acid strength; and (3) the ratio of trans-1,2-DCMP to trans-1,3-DCMP correlates with the constraint at the catalyst active site wherein a high ratio (>1) indicates little or no physical constraint at the active site and a low ratio (<1) indicates a physical constraint at the active site.

In the present process, to produce a catalyst that will give improved low temperature properties, the ratio of trans-1,2-DCMP to trans-1,3-DCMP is adjusted to from 1:1 to 2:1 predominately by controlling the acid strength of the amorphous isomerization component. It is preferred to use higher acid strength amorphous components such as silica-alumina.

Conversely, a catalyst that will give high yield is produced by decreasing the acid strength of the amorphous phase. In this case it is preferred to use lower acid strength amorphous components such as alumina. Another way of making such a catalyst is by changing the ratio of the microporous component to the amorphous component such that the unitized catalyst has a trans-1,2 trans-1,3 DMCP ratio of less than 1.

The hydrodewaxing process utilizing the catalyst of the present invention is conducted at temperatures between about 200° C. to 400° C., preferably 250° C. to 380° C. and most preferably 300° C. to 350° C. at pressures between about 500 to 5,000 psig (3.55 to 34.6 mPa), preferably 1,000 to 2000 psig (7.0 to 13.9 mPa), a hydrogen gas treat ratio of 500 to 10000 SCF H₂/B (89 to 1780 m³/m³), preferably 2,000 to 5,000 SCF H₂/B (356 to 890 m³/m³) and a LHSV of 0.5 to 5 v/v/hr, preferably 1 to 2 v/v/hr.

In an alternate embodiment of the present invention the feed is first subjected to solvent dewaxing to a pour point on the order of +10° C. or lower.

The dewaxing solvent used may include the C₃-C₆ ketones such as methyl ethyl ketone (MEK), methyl isobutyl ketone (MIBK), mixtures of MEK and MIBK, aromatic hydrocarbons like toluene, mixtures of ketones and aromatics like MEK/toluene, ethers such as methyl t-butyl ethers and mixtures of same with ketones or aromatics. Similarly, liquefied, normally gaseous hydrocarbons like propane, propylene, butane, butylene, and combinations thereof may be used as the solvent. Preferably the solvent employed will be an equal volume mixture of methyl ethyl ketone and methyl isobutyl ketone. Typically the isomerate to solvent ratio will range between 1 to 10 and preferably will be about 1:3. The dewaxed feed is then subjected to hydrodewaxing as described hereinabove.

The present invention is demonstrated below in the non-limiting examples.

### EXAMPLES

### Comparative Example 1

A catalyst (B) comprising 0.5 wt. % Pt ZSM-5 (silica/alumina ratio 220:1) and alumina in the weight ratio of 25:75, was used in two runs to dewax a hydrocrackate distillate having the following properties:

| | |
|---|---|
| KV, cSt at 100° C. | 3.808 |
| KV, cSt at 135° C. | 2.28 |
| Pour Point, ° C. | 39 |
| Boiling Range (GCD) | 325-503° C. |

The dewaxing conditions employed are listed in the accompanying Table. The results are shown in column B of the Table following Example 2.

When screened for activity and selectivity with methylcyclohexane, this catalyst had an ECP selectivity of 40 and a t-1,2/t-1,3 dimethylcylopentane ratio of 0.02 as shown in the Table. A comparison of columns A and B of the Table shows that the VI of the resulting liquid product (350° C.+) was lower than that obtained by solvent dewaxing. The product low temperature properties, as shown by the Brookfield Viscosity at −40° C. (additized with a standard Ford type ATF adpack), are also shown in the Table. The Brookfield Viscosity is reduced by catalytic dewaxing over that of a solvent dewaxed product. However, the Brookfield Viscosities of both solvent and cat dewaxed products are very poor.

### Comparative Example 2

A catalyst (C) comprising 0.5 wt. % Pt ZSM-5 (silica/alumina ratio 220:1) and silica-alumina in the weight ratio of 50:50, was used to dewax a hydrocrackate distillate having the properties noted in Comparative Example 1. This catalyst was made by combining the powdered ZSM-5 (Si/Al ratio 110) with the powdered amorphous component in the weight ratio of 50:50 and then loading platinum by incipient wetness using platinum tetraamine dichloride.

When screened for activity and selectivity with methylcyclohexane, this catalyst had an ECP selectivity of 47 and a t-1,2/t-1,3 dimethylcylopentane ratio of 0.82 as shown in the Table following Example 2. A comparison of columns A and C, in the Table shows that the VI of the resulting liquid product (350° C.+) was lower than that obtained by solvent dewaxing. The product low temperature properties, as shown by the Brookfield Viscosity −40° C. (additized with a standard Ford type ATF adpack), are also shown in the Table. The Brookfield Viscosity is reduced by catalytic dewaxing over that of a solvent dewaxed product but not significantly over that obtained using the alumina bound catalyst in Example 1.

### Example 1

A catalyst (D) comprising 0.5 wt. % Pt ZSM-5 (silica/alumina ratio 220:1) and silica alumina in the weight ratio of 10:90, was used to dewax a hydrocrackate distillate having the properties noted in Comparative Example 1. This catalyst was made by combining the powdered ZSM-5 (Si/Al ratio 110) with the powdered amorphous component in the weight ratio of 10:90 respectively and then loading platinum by incipient wetness using platinum tetraamine dichloride.

When screened for activity and selectivity with methylcyclohexane, this catalyst had an ECP selectivity of 50 and a t-1,2/t-1,3 dimethylcylopentane ratio of 1.80 as shown in the Table following Example 2. Both of these values are within the criteria for catalysts of this invention. A comparison of columns A and D, in the Table shows that the VI of the resulting liquid product (350° C.+) was higher than that obtained by solvent dewaxing. The product low temperature properties, as shown by the Brookfield Viscosity at −40° C. (addized in a standard ECA/ATF adpack), are also shown in the Table. The Brookfield Viscosity is significantly reduced by catalytic dewaxing with this catalyst over that of a solvent dewaxed product of the Table.

### Example 2

The procedure of Example 1 was followed using 0.5 wt. % on Pt on theta-1 (TON) on silica-alumina (Catalyst E) and 0.5 wt. % Pd on Al₂O₃ in the weight ratio of 25:75 (Catalyst F-Comparative). Theta-1 is a 10 ring zeolite and is described in EP 057049. This catalyst was made by combining the powdered TON zeolite (Si/Al ratio 30) with the powdered amorphous component in different ratios and then loading platinum by incipient wetness using platinum tetraamine dichloride. The condition and results are set out in columns E and F of the Table.

TABLE 1

| | | | | C | | D | | E | |
|---|---|---|---|---|---|---|---|---|---|
| | A | B | | Pt ZSM-5 (50) | | Pt ZSM-5 (10) | | Pd TON (25) | F |
| | Solvent | Pt ZSM-5 (25) | | Silica- | | Silica- | | Pt Silica- | Pt TON (25) |
| Catalyst (wt. %) | Dewaxing | Alumina (75) | | Alumina (50) | | Alumina (90) | | Alumina (75) | Al₂O₃ (75) |
| CONDITIONS | | | | | | | | | |
| Average Reactor | | 314 | 329 | 314 | 329 | 329 | 339 | 304 | 314 |
| Temperature, ° C. | | | | | | | | | |
| Pressure, psig | | 1000 | | 1000 | | 1000 | | 1000 | 1000 |
| v/v/hr | | 1 | | 1 | | 1 | | 1 | 1 |
| T G Rate, scf/bbl | | 2500 | | 2500 | | 2500 | | 2500 | 2500 |
| PRODUCT | | | | | | | | | |
| PROPERTIES | | | | | | | | | |
| 350° C.+, Yield | 75 | 72 | 55 | 65 | 50 | 55 | 45 | 75 | 78 |
| Viscosity, cSt at 100° C. | 3.94 | 4.07 | 4.37 | 4.1 | 4.05 | 3.83 | 3.81 | 3.9 | 3.91 |
| Viscosity, cSt at 40° C. | 18.56 | 19.48 | 22.41 | 19.528 | 19.84 | 17.33 | 17.306 | 17.663 | 17.713 |
| VI | 110 | 108 | 102 | 106 | 102 | 112 | 109 | 115 | 116 |
| Pour Point, ° C. | −21 | −14 | −35 | −23 | −43 | −20 | −36 | −21 | −16 |
| Brookfield Viscosity, | >25,000 | 18,400 | 22,600 | 18,000 | 16,000 | 12,800 | 12,000 | 12,000 | 17,000 |
| cP at −40° C. | | | | | | | | | |
| MCH | | | | | | | | | |
| Conversion, at 320° C. | n/a | 11.4 | | 10.6 | | 12 | | 18.2 | 9.9 |
| ECP | n/a | 40 | | 47 | | 50 | | 61 | 70 |
| trans-1,2/trans-1,3 | n/a | 0.02 | | 0.82 | | 1.8 | | 1.15 | 0.12 |
| DMCP | | | | | | | | | |

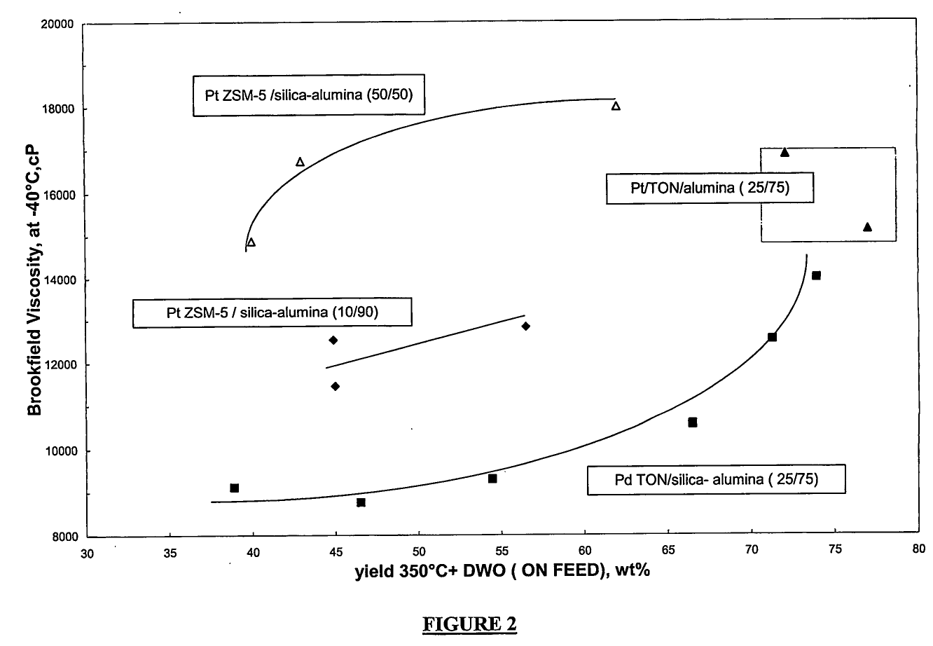

The results shown in the Table are further illustrated in FIG. 2 which is a graph showing Brookfield viscosity vs. yield for various catalyst combinations.

1. A method for hydrodewaxing feeds to produce a lube basestock having improved low temperature properties which comprises:
a) contacting the feed with a unitized mixed powder pellet catalyst under hydrodewaxing conditions, said catalyst comprising:
i) at least one first component selected from 10 and 12 ring molecular sieves and mixtures thereof having a metal hydrogenation component dispersed thereon;
(ii) at least one second component selected from 10 and 12 ring molecular sieves and mixtures thereof having a metal hydrogenation component dispersed thereon; and
(iii) wherein said first and second components are present in a ratio such that when evaluated in the conversion of methyl cyclohexane at 320° C. to 1,1-dimethylcyclopentane, 1,2-dimethylcyclopentane, 1,3-dimethylcyclopentane and ethylcyclopentane, the catalyst will provide a trans-1,2-/trans-1,3-dimethylcyclopentane ratio in the range of about 1:1 to about 1:2 and a selectivity to ethylcyclopentane, at 10% conversion, of at least about 50%.

2. The process of claim 1 wherein the 10 and 12 ring molecular sieves are selected from alumino silicates and alumino phosphates.

3. The process of claim 2 wherein the alumino silicates are selected from ZSM-5, ZSM-11, ZSM-12, ZSM-22, ZSM-23, ZSM-35, natural and synthetic ferrierites, ZSM-48, ZSM-57, Beta Mordenite, Offretite, ECR-42, MCM-71, and ITQ-13.

4. The process according to claim 3 wherein said at least one first component is selected from ITQ-13, ZSM-57, and mixtures thereof, and said at least one second component is selected from ZSM-22, ZSM-23, ZSM-35, ZSM-48, SSZ-31, and mixtures thereof.

5. The process of claim 4 wherein said at least one first component is ITQ-13 and said at least one second component is selected from ZSM48, ZSM-35, ZSM-22, ZSM-23, ZSM-57, SSZ-31, and mixtures thereof.

6. The process of claim 2 wherein in the second component when evaluated in the conversion of methylcyclohexane at 320° C. will exhibit a selectivity for ECP formation of at least 50% or greater.

7. The process of claim 1 wherein the feed is solvent dewaxed to a pour point of up to +10° C.

8. The process of claim 1 wherein the feed is hydrotreated at temperatures in the range 280° C. to 400° C., at pressures in the range 500 to 3000 psi, hydrogen treat gas rate in the range of 500 to 5000 SCF/bbl and a flow velocity in the range 0.1 to 5 LHSV.

9. The method of claim 1 wherein the metal hydrogenation component is at least one of a Group VI or Group VIII metal.

10. The method of claim 2 wherein the metal hydrogenation component is at least one Group VIII metal.

11. The method of claim 10 wherein the metal hydrogenation component is selected from Pt, Pd, and mixtures thereof.

12. The method of claim 1 wherein the hydrogenation component is dispersed in an amount ranging from about 0.1 wt. % to about 30 wt. %.
